(19) United States
(12) Patent Application Publication
(10) Pub. No.: US 2024/0322188 A1
(43) Pub. Date: Sep. 26, 2024

(54) SOLID-STATE BATTERY

(71) Applicant: MURATA MANUFACTURING CO., LTD., Kyoto (JP)

(72) Inventors: Tatsushiro HIRATA, Kyoto (JP); Keisuke SHIMIZU, Kyoto (JP); Katsuaki HIGASHI, Kyoto (JP); Takahiro HAYAKAWA, Kyoto (JP)

(21) Appl. No.: 18/677,272

(22) Filed: May 29, 2024

Related U.S. Application Data
(63) Continuation of application No. PCT/JP2022/039328, filed on Oct. 21, 2022.

(30) Foreign Application Priority Data
Dec. 28, 2021 (JP) 2021-214672

(51) Int. Cl. H01M 4/66; H01M 10/0525; H01M 10/0562

(52) U.S. Cl. CPC H01M 4/668; H01M 10/0525; H01M 10/0562

(57) ABSTRACT

Provided is a solid-state battery capable of further reducing cracks due to expansion of the battery during charging. A solid-state battery includes: a battery element in which a positive electrode layer, a negative electrode layer, and a solid electrolyte layer interposed between the positive electrode layer and the negative electrode layer are stacked; an end-face electrodes provided on an end face of the battery element; and an insulating layer provided between the positive electrode layer or the negative electrode layer and the end-face electrodes, in which the insulating layer contains a heat-resistant resin.

### CROSS REFERENCE TO RELATED APPLICATIONS

The present application is a continuation of PCT patent application no. PCT/JP2022/039328, filed on Oct. 21, 2022, which claims priority to Japanese patent application no. 2021-214672, filed on Dec. 28, 2021, the entire contents of which are incorporated herein by reference.

### BACKGROUND

The present disclosure relates to a solid-state battery.

Conventionally, secondary batteries that can be repeatedly charged and discharged have been used for various applications. For example, secondary batteries are used as power sources of electronic devices such as smart phones and laptop computers.

In secondary batteries, a liquid electrolyte is generally used as a medium for ion transfer contributing to charging and discharging. That is, a so-called electrolytic solution is used for the secondary battery. However, in such a secondary battery, safety is generally required from the viewpoint of preventing leakage of an electrolytic solution. Since an organic solvent or the like used for the electrolytic solution is a flammable substance, safety is required also in that respect.

Thus, a solid-state battery using a solid electrolyte instead of an electrolytic solution has been studied.

### SUMMARY

The present disclosure relates to a solid-state battery.

An all-solid-state battery is disclosed having a structure in which an electrode assembly is embedded in a solid electrolyte in a state of being stacked with a current collector layer interposed therebetween. The inventor of the present application has found that, when a voltage is applied from the outside to the all-solid-state battery to charge the battery, cracks occur in the solid electrolyte due to expansion of the electrode assembly and the current collector layer.

Here, An all-solid-state battery is described including a margin layer provided on the same plane as a positive electrode layer or a negative electrode layer, and a gap adjacent at one end of the positive electrode layer or the negative electrode layer, as a method for suppressing cracks due to volume expansion and contraction of an electrode layer occurred during charging and discharging of the all-solid-state battery.

In addition, an all-solid-state battery is disclosed having a structure different from those of the all-solid-state batteries described above, in which a current collector layer is provided on an upper end face and a lower end face in the stacking direction, and the side face of the current collector layer is covered with a resin layer.

In addition, An all-solid-state battery is described that suppresses an internal short circuit when expansion and contraction of a solid electrolyte layer occurs due to charging and discharging, an all-solid-state battery having an electrical insulating frame having a hollow structure, and an adhesion improving region that is formed at an interface between the solid electrolyte layer and the electrical insulating frame and prevents an internal short circuit.

In addition, an all-solid-state battery is described that prevents a short circuit between a positive electrode layer and a negative electrode layer, an all-solid-state battery including an insulator on an outer peripheral portion of a solid electrolyte layer.

However, in the all-solid-state batteries described above, cracks due to expansion of the battery during charging are not sufficiently improved, and there is room for further improvement. Therefore, the present disclosure relates to providing, in an embodiment, a solid-state battery capable of further reducing cracks due to expansion of the battery during charging.

The present disclosure relates to providing, in an embodiment, a solid-state battery capable of further reducing cracks due to expansion of the battery during charging.

In the present disclosure, in an embodiment, there is provided a solid-state battery including:
a battery element in which a positive electrode layer, a negative electrode layer, and a solid electrolyte layer interposed between the positive electrode layer and the negative electrode layer are stacked;
an end-face electrode provided on an end face of the battery element; and
an insulating layer provided between the positive electrode layer or the negative electrode layer and the end-face electrode, in which the insulating layer contains a heat-resistant resin.

In the solid-state battery according to the present disclosure, in an embodiment, since the insulating layer contains a heat-resistant resin, it is possible to further reduce cracks due to expansion of the battery during charging.

### BRIEF DESCRIPTION OF THE FIGURES

FIG. 1A is a sectional view of a solid-state battery according to an embodiment of the present disclosure.

FIG. 1B is a sectional view taken along line i-i in FIG. 1A in a direction of arrows.

FIG. 1C is a sectional view of a modification example of the solid-state battery according to an embodiment of the present disclosure.

FIG. 1D is a sectional view taken along line ii-ii in FIG. 1A in a direction of arrows.

FIG. 2A is a sectional view of a solid-state battery according to another embodiment of the present disclosure. FIG. 2B is a sectional view taken along line iii-iii in FIG. 2A in a direction of arrows.

FIG. 3A is a sectional view of a solid-state battery according to a further embodiment of the present disclosure.

FIG. 3B is a sectional view of a modification example of the solid-state battery according to a further embodiment of the present disclosure.

FIG. 3C is a sectional view of another modification example of the solid-state battery according to a further embodiment of the present disclosure.

### DETAILED DESCRIPTION

Hereinafter, a “solid-state battery” of the present disclosure will be described in further detail according to an embodiment. Although the description will be made with reference to the drawings as necessary, the illustrated contents are only schematically and exemplarily illustrated for the understanding of the present disclosure, and the appearance and/or the dimensional ratio and the like may be different from the actual ones. Unless otherwise specified, the same reference signs or symbols denote the same members or sites, or the same semantic contents for convenience of description.

The term “solid-state battery” used in the present disclosure refers to a battery whose constituent elements are constituted of solids in a broad sense, and refers to an all-solid-state battery whose constituent elements (particularly preferably all constituent elements) are constituted of solids in a narrow sense. In a preferred aspect, the solid-state battery in the present disclosure is a stacked solid-state battery configured such that layers constituting a battery constituent unit are stacked with each other, and preferably such layers are composed of a sintered body.

The term “solid-state battery” encompasses not only a so-called “secondary battery” that can be repeatedly charged and discharged but also a “primary battery” that can only be discharged. In a preferred aspect of the present disclosure, the “solid-state battery” is a secondary battery. The term “secondary battery” is not excessively limited by its name, and can encompass, for example, an electrochemical device such as a “power storage device”.

The term “plan view” as used in the present specification is based on a sketch drawing in a case where an object is captured from an upper side or a lower side along a thickness direction based on a stacking direction of each layer constituting the solid-state battery.

The term “sectional view” as used herein is based on a form (in other words, a form in the case of being cut along a plane parallel to a stacking direction) where an object is viewed from a direction substantially perpendicular to a thickness direction based on a stacking direction of each layer constituting the solid-state battery.

The “vertical direction” and “horizontal direction” used directly or indirectly in the present specification correspond to a vertical direction and a horizontal direction in the drawings, respectively. According to a preferred aspect, it can be understood that the downward direction in the vertical direction (that is, the direction in which gravity acts) corresponds to a “downward direction”, whereas the opposite direction corresponds to an “upward direction”.

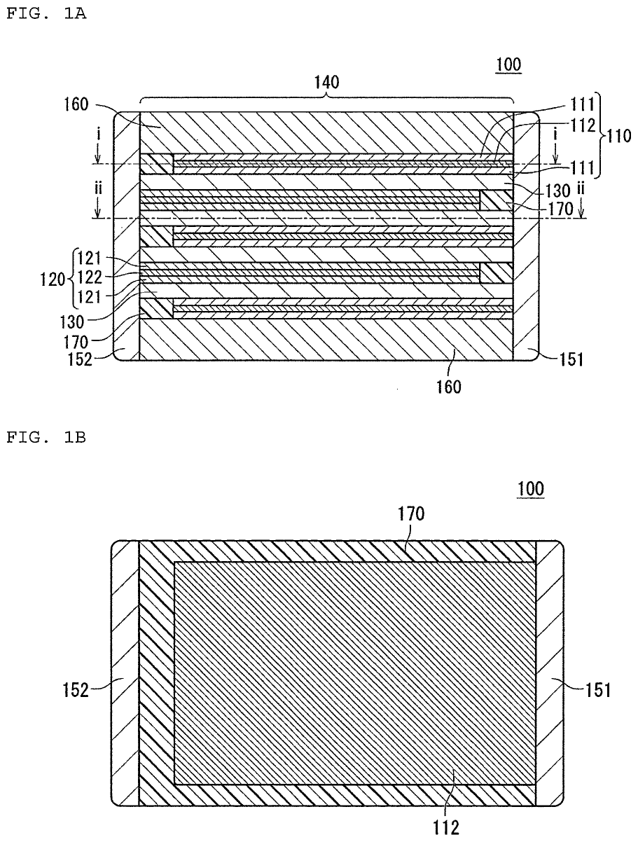

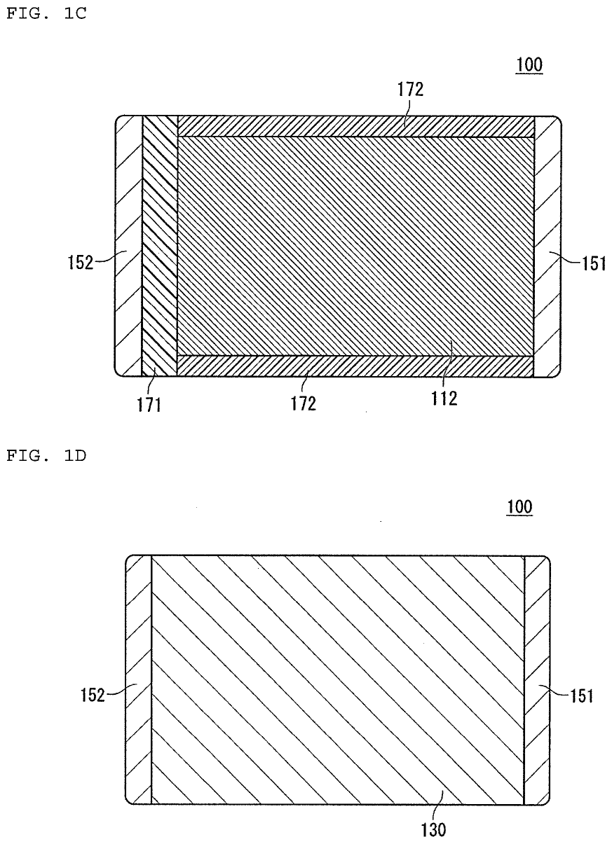

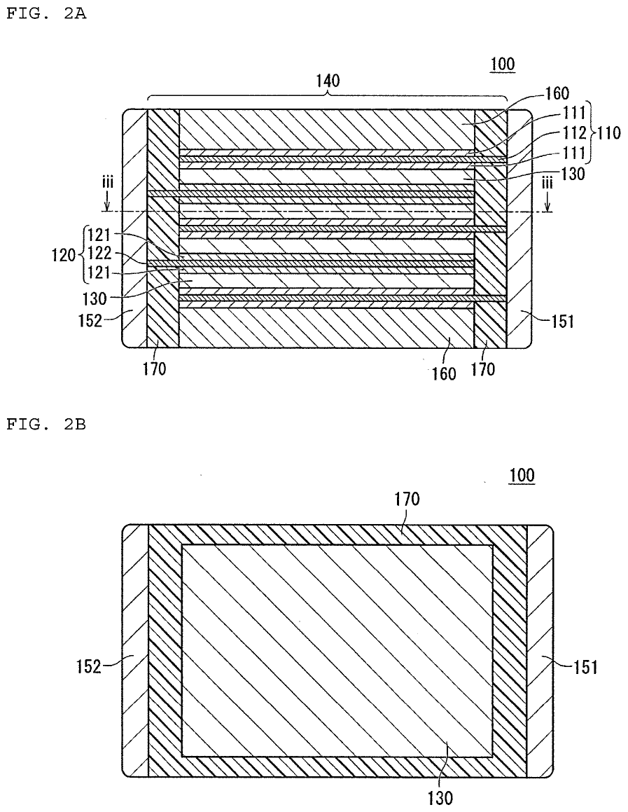

A solid-state battery 100 includes a battery element 140 in which a positive electrode layer 110, a negative electrode layer 120, and a solid electrolyte layer 130 interposed therebetween are stacked, end-face electrodes 151 and 152 provided on end faces of the battery element 140 and electrically connected to the battery element 140, and an insulating layer 170 provided between the positive electrode layer 110 or the negative electrode layer 120 and the end-face electrodes 151 and 152 (see, FIG. 1). In the present embodiment, the solid-state battery 100 in which the positive electrode layer 110 and the negative electrode layer 120 can store and release lithium ions will be described, but the present disclosure is not limited to this example. The solid-state battery 100 may also be a solid-state battery in which the positive electrode layer 110 and the negative electrode layer 120 store and release sodium ions.

The battery element 140 may be formed by firing each layer constituting the battery element 140. The positive electrode layer 110, the negative electrode layer 120, the solid electrolyte layer 130, and the like may form a fired layer. Preferably, the positive electrode layer 110, the negative electrode layer 120, the solid electrolyte layer 130, and the insulating layer 170 are each fired integrally with each other, and thus the battery element 140 may form an integrally fired body. In the present specification, a direction (vertical direction) in which the positive electrode layer 110 and the negative electrode layer 120 are stacked is referred to as a “stacking direction”, and a direction intersecting the stacking direction is a horizontal direction in which the positive electrode layer 110 and the negative electrode layer 120 extend.

The positive electrode layer 110 is an electrode layer including at least a positive electrode active material layer 111. The positive electrode layer 110 may further contain a solid electrolyte. In a preferred aspect, the positive electrode layer 110 is composed of a sintered body including at least positive electrode active material particles and solid electrolyte particles. On the other hand, the negative electrode layer 120 is an electrode layer including at least a negative electrode active material layer 121. The negative electrode layer 120 may further contain a solid electrolyte. In a preferred aspect, the negative electrode layer 120 is composed of a sintered body containing at least negative electrode active material particles and solid electrolyte particles.

Here, the positive electrode active material and the negative electrode active material are substances involved in accepting and donating electrons in the solid-state battery. Ion movement (or conduction) between the positive electrode layer and the negative electrode layer with the solid electrolyte interposed therebetween and accepting and donating of electrons between the positive electrode layer and the negative electrode layer with an external terminal interposed therebetween are performed, so that charge and discharge are performed. The positive electrode layer 110 and the negative electrode layer 120 may include a current collector layer.

Although FIG. 1 shows a configuration in which three positive electrode layers 110 and two negative electrode layers 120 are stacked, the number of stacked layers is not limited to this example, and the number of stacked layers may be one, or several tens to several hundreds of layers may be stacked. The film thickness of the positive electrode layer or the negative electrode layer may be 5 μm or more and 60 μm or less, and preferably 8 μm or more and 50 μm or less. The film thickness may be 5 μm or more and 30 μm or less.

The positive electrode active material contained in the positive electrode active material layer 111 is, for example, a lithium-containing compound or a sodium-containing compound. The type of the lithium-containing compound is not particularly limited, and examples of the lithium-containing compound include a lithium transition metal composite oxide and/or a lithium transition metal phosphate compound. The lithium transition metal composite oxide is a generic term for oxides containing lithium and one or two or more types of transition metal elements as constituent elements. The lithium transition metal phosphate compound is a generic term for phosphate compounds containing lithium and one or two or more types of transition metal elements as constituent elements. The type of transition metal element is not particularly limited, and examples of the transition metal element include cobalt (Co), nickel (Ni), manganese (Mn), and/or iron (Fe).

The lithium transition metal composite oxide is, for example, a compound represented by LiₓM1O₂ and Li_{y}M2O₄. The lithium transition metal phosphate compound is, for example, a compound represented by Li_{z}M3PO₄. Note that, each of M1, M2, and M3 is one or two or more types of transition metal elements. The respective values of x, y, and z are optional.

Specifically, examples of the lithium transition metal composite oxide include LiCoO₂, LiNiO₂, LiVO₂, LiCrO₂, LiMn₂O₄, LiCo_{1/3}Ni_{1/3}Mn_{1/3}O₂, and LiNi_{0.5}Mn_{1.5}O₄. Examples of the lithium transition metal phosphate compound include LiFePO₄, LiCoPO₄, and LiMnPO₄. The lithium transition metal composite oxide (particularly LiCoO₂) may contain a trace amount (about several %) of an additive element. Examples of the additive element include one or more types of elements selected from the group consisting of aluminum (Al), magnesium (Mg), nickel (Ni), manganese (Mn), titanium (Ti), boron (B), vanadium (V), chromium (Cr), iron (Fe), copper (Cu), zinc (Zn), molybdenum (Mo), tin (Sn), tungsten (W), zirconium (Zr), yttrium (Y), niobium (Nb), calcium (Ca), strontium (Sr), bismuth (Bi), sodium (Na), potassium (K), and silicon (Si).

In addition, examples of the positive electrode active material capable of storing and releasing sodium ions include at least one selected from the group consisting of sodium-containing phosphate compounds having a NASICON-type structure, sodium-containing phosphate compounds having an olivine-type structure, sodium-containing layered oxides, sodium-containing oxides having a spinel-type structure, and the like.

The content of the positive electrode active material in the positive electrode active material layer 111 is usually 50 wt % or more, for example, 60 wt % or more with respect to the total amount of the positive electrode active material layer 111. The positive electrode active material layer 111 may contain two or more types of the positive electrode active materials, and in that case, the total content thereof may be within the above range. When the content of the active material is 50 mass % or more, the energy density of the battery can be particularly increased.

Examples of the negative electrode active material contained in the negative electrode active material layer 121 include a carbon material, a metal-based material, a lithium alloy and/or a lithium-containing compound.

Specifically, examples of the carbon material include graphite, graphitizable carbon, non-graphitizable carbon, mesocarbon microbeads (MCMB), and/or highly oriented graphite (HOPG).

The metal-based material is a generic term for a material containing any one or two or more types of metal elements and metalloid elements capable of forming alloy with lithium as constituent elements. The metal-based material may be a simple substance, an alloy, or a compound. Since the purity of the simple substance described here is not necessarily limited to 100%, the simple substance may contain a trace amount of impurities.

Examples of the metal element and the metalloid element include silicon (Si), tin (Sn), aluminum (Al), indium (In), magnesium (Mg), boron (B), gallium (Ga), germanium (Ge), lead (Pb), bismuth (Bi), cadmium (Cd), titanium (Ti), chromium (Cr), iron (Fe), niobium (Nb), molybdenum (Mo), silver (Ag), zinc (Zn), hafnium (Hf), zirconium (Zr), yttrium (Y), palladium (Pd), and/or platinum (Pt).

Specifically, examples of the metal-based material include Si, Sn, SiB₄, TiSi₂, SiC, Si₃N₄, SiOᵥ (0<v≤2), LiSiO, SnO_{w} (0<w≤2), SnSiO₃, LiSnO, and/or, Mg₂Sn.

The lithium-containing compound is, for example, a lithium transition metal composite oxide. The definition regarding the lithium transition metal composite oxide is as described above. Specifically, the lithium transition metal composite oxide is, for example, Li₃V₂(PO₄)₃, Li₃Fe₂(PO₄)₃, Li₄Ti₅O₁₂, LiTi₂(PO₄)₃, and/or LiCuPO₄.

Examples of the negative electrode active material capable of storing and releasing sodium ions include at least one selected from the group consisting of a sodium-containing phosphate compound having a NASICON-type structure, a sodium-containing phosphate compound having an olivine-type structure, a sodium-containing oxide having a spinel-type structure, and the like.

The content of the negative electrode active material in the negative electrode active material layer 121 is usually 50 wt % or more, for example, 60 wt % or more with respect to the total amount of the negative electrode active material portion. The negative electrode active material portion may contain two or more types of negative electrode active materials, and in that case, the total content thereof may be within the above range. When the content of the active material is 50 mass % or more, the energy density of the battery can be particularly increased.

The positive electrode active material layer 111 and/or the negative electrode active material layer 121 may contain a conductive material. Examples of the conductive material contained in the positive electrode active material layer 111 and/or the negative electrode active material layer 121 include a carbon material and a metal material. Specific examples of the carbon material include graphite and carbon nanotubes. Examples of the metal material include copper (Cu), magnesium (Mg), titanium (Ti), iron (Fe), cobalt (Co), nickel (Ni), zinc (Zn), aluminum (Al), germanium (Ge), indium (In), gold (Au), platinum (Pt), silver (Ag), and/or palladium (Pd), and an alloy of two or more of them.

The positive electrode active material layer 111 and/or the negative electrode active material layer 121 may contain a binder. The binder is, for example, any one or two or more types of synthetic rubbers and polymer materials. Specifically, examples of the synthetic rubber include styrene-butadiene-based rubber, fluorine-based rubber, and/or ethylene propylene diene. Examples of the polymer material include at least one selected from the group consisting of polyvinylidene fluoride, polyimide, and acrylic resin.

Further, the positive electrode active material layer 111 and/or the negative electrode active material layer 121 may contain a sintering aid. Examples of the sintering aid include at least one selected from the group consisting of a lithium oxide, a sodium oxide, a potassium oxide, a boron oxide, a silicon oxide, a bismuth oxide, and a phosphorus oxide.

The thickness of each of the positive electrode active material layer 111 and the negative electrode active material layer 121 is not particularly limited, and may be, for example, 2 μm or more and 100 μm or less, and particularly 5 μm or more and 50 μm or less, independently of each other.

A positive electrode current collector layer 112 and a negative electrode current collector layer 122 preferably have higher electron conductivity than those of the positive electrode active material layer 111 and the negative electrode active material layer 121.

As the positive electrode current collector layer 112, for example, at least one selected from the group consisting of a carbon material, silver, palladium, gold, platinum, aluminum, copper, a nickel lithium transition metal composite oxide, and a lithium transition metal phosphate compound may be used.

As the negative electrode current collector layer 122, for example, at least one selected from the group consisting of a carbon material, silver, palladium, gold, platinum, aluminum, copper, and nickel may be used.

Each of the positive electrode current collector layer 112 and/or the negative electrode current collector layer 122 may have an electrical connection portion for electrical connection with the outside, and may be configured to be electrically connectable to a terminal electrode. Each of the positive electrode current collector layer 112 and the negative electrode current collector layer 122 may be in the form of a foil. The positive electrode current collector layer 112 and the negative electrode current collector layer 122 are preferably in the form of an integrally sintered body from the viewpoint of improvement in conductivity and reduction in manufacturing cost due to integral sintering.

When the positive electrode current collector layer 112 and/or the negative electrode current collector layer 122 are in the form of a fired body, for example, the positive electrode current collector layer 112 and/or the negative electrode current collector layer 122 may be composed of a sintered body containing a conductive material, an active material, a solid electrolyte, a binder, and/or a sintering aid. The conductive material contained in the positive electrode current collector layer 112 and the negative electrode current collector layer 122 may be selected from, for example, materials similar to the conductive material that can be contained in the positive electrode active material layer 111 and/or the negative electrode active material layer 121. The solid electrolyte, the binder, and/or the sintering aid contained in the positive electrode current collector layer 112 and the negative electrode current collector layer 122 may be selected from, for example, materials similar to the solid electrolyte, the binder, and/or the sintering aid that can be contained in the positive electrode active material layer 111 and/or the negative electrode active material layer 121.

The positive electrode current collector layer 112 and/or the negative electrode current collector layer 122 may also contain a heat-resistant resin. When the current collector layer contains a heat-resistant resin, cracks generated by expansion of the current collector layer can be suppressed.

The thickness of each of the positive electrode current collector layer 112 and the negative electrode current collector layer 122 is not particularly limited, and may be, for example, 1 μm or more and 100 μm or less, and particularly 1 μm or more and 50 μm or less, independently of each other.

The solid electrolyte constituting the solid electrolyte layer 130 is a material capable of conducting lithium ions or sodium ions. In particular, the solid electrolyte constituting a battery constituent unit in the solid-state battery forms a layer capable of conducting lithium ions or sodium ions between the positive electrode layer 110 and the negative electrode layer 120. It is to be noted that the solid electrolyte has only to be provided at least between the positive electrode layer 110 and the negative electrode layer 120. That is, the solid electrolyte may also exist around the positive electrode layer 110 and/or the negative electrode layer 120 so as to protrude from between the positive electrode layer 110 and the negative electrode layer 120. Specific examples of the solid electrolyte include any one or two or more types of a crystalline solid electrolyte, a glass-based solid electrolyte, and a glass ceramic-based solid electrolyte.

Examples of the crystalline solid electrolyte include oxide-based crystal materials and sulfide-based crystal materials. Examples of the oxide-based crystal material include LiₓM_{y}(PO₄)₃ having a NASICON structure (1≤x≤2, 1≤y≤2, M is at least one selected from the group consisting of Ti, Ge, Al, Ga, and Zr, and for example, Li_{1.3}Al_{0.3}Ti_{1.7}(PO₄)₃) , La_{0.51}Li_{0.34}TiO_{2.94} having a perovskite structure, and Li₇La₃Zr₂O₁₂ having a garnet structure. In addition, examples of the sulfide-based crystal material include thio-LISICON, and specifically, Li_{3.25}Ge_{0.25}P_{0.75}S₄ and Li₁₀GeP₂S₁₂. The crystalline solid electrolyte may contain a polymer material (for example, a polyethylene oxide (PEO)).

Examples of the glass-based solid electrolyte include oxide-based glass materials and sulfide-based glass materials. Examples of the oxide-based glass material include 50Li₄SiO₄-50Li₃BO₃. In addition, examples of the sulfide-based glass material include 30Li₂S-26B₂S₃-44LiI, 63Li₂S-36SiS₂-1Li₃PO₄, 57Li₂S-38SiS₂-5Li₄SiO₄, 70Li₂S-30P₂S₅, and 50Li₂S-50GeS₂.

Examples of the glass ceramic-based solid electrolyte include oxide-based glass ceramic materials and sulfide-based glass ceramic materials. As the oxide-based glass ceramic material, for example, a phosphate compound (LATP) containing lithium, aluminum, and titanium as constituent elements, and a phosphate compound (LAGP) containing lithium, aluminum, and germanium as constituent elements can be used. LATP is, for example, Li_{1.07}Al_{0.69}Ti_{1.46}(PO₄)₃. LAGP is, for example, Li_{1.5}Al_{0.5}Ge_{1.5}(PO₄). In addition, examples of the sulfide-based glass ceramic material include Li₇P₃S₁₁ and Li_{3.25}P_{0.95}S₄.

When more emphasis is placed on the viewpoint of achieving excellent atmospheric stability and easy integral sintering, the solid electrolyte may contain at least one selected from the group consisting of an oxide-based crystal material, an oxide-based glass material, and an oxide-based glass ceramic material.

In addition, examples of the solid electrolyte capable of conducting sodium ions include sodium-containing phosphate compounds having a NASICON structure, oxides having a perovskite structure, and oxides having a garnet-type or garnet-type similar structure. Examples of the sodium-containing phosphate compound having a NASICON structure include NaₓM_{y}(PO₄)₃(1≤x≤2, 1≤y≤2, and M is at least one selected from the group consisting of Ti, Ge, Al, Ga, and Zr).

The solid electrolyte layer may contain a binder and/or a sintering aid. The binder and/or the sintering aid contained in the solid electrolyte layer may be selected from, for example, materials similar to the binder and/or the sintering aid that can be contained in the positive electrode active material portion and/or the negative electrode active material portion.

The thickness of the solid electrolyte layer is not particularly limited, and may be, for example, 1 μm or more and 15 μm or less, particularly 1 μm or more and 5 μm or less.

The insulating layer 170 acts as an electrode separation portion (also referred to as a “margin portion” or a “margin layer”) for achieving electrical insulation between the positive electrode layer 110 and an end-face electrode 152 on the negative electrode layer side, or between the negative electrode layer 120 and an end-face electrode 151 on the positive electrode layer side (see, FIG. 1A). The insulating layer 170 may be made of at least a material (insulating material) that does not allow electricity to pass therethrough. Further, the insulating layer 170 may be porous. In a case where the insulating layer 170 is made of a material that does not conduct electricity, a material having an electrical resistivity of 10¹² Ω·m or more is preferable.

The insulating layer 170 contains a heat-resistant resin. The term “heat-resistant resin” as used herein is intended to be able to withstand heat caused by charging of the battery and firing of the layers constituting the solid-state battery (the firing temperature is about 300° C. to 800° C.).

Examples of the heat-resistant resin include imide-based resins and/or imidazole-based resins. Examples of the imide-based resin include a polyimide resin (for example, glass transition temperature: 300 to 500° C., thermal decomposition temperature: about 600° C.) and a polyamideimide resin (for example, glass transition temperature: 250 to 350° C., thermal decomposition temperature: about 370° C.) . Examples of the imidazole-based resin include a polybenzimidazole resin (for example, glass transition temperature: 420 to 435° C., thermal decomposition temperature: about 600° C.). The thermal decomposition temperature can be measured by thermogravimetry-differential calorimetry (TD-DTA).

The insulating layer 170 is provided around the positive electrode layer 110 (the positive electrode active material layer 111 and the positive electrode current collector layer 112) to thereby separate the positive electrode layer 110 from the end-face electrode 152 on the negative electrode layer side (see, FIG. 1B). The insulating layer 170 is provided around the negative electrode layer 120 (the negative electrode active material layer 121 and the negative electrode current collector layer 122) to thereby separate the negative electrode layer 120 from the end-face electrode 151 on the positive electrode layer side. That is, the insulating layer 170 may be disposed between the negative electrode layer 120 and the end-face electrode 151 on the positive electrode layer side and/or between the positive electrode layer 110 and the end-face electrode 152 on the negative electrode layer side.

Meanwhile, since the positive electrode layer 110 (the positive electrode active material layer 111 and the positive electrode current collector layer 112) is electrically connected to the end-face electrode 151 on the positive electrode layer side, the insulating layer 170 is not disposed between the positive electrode layer 110 and the end-face electrode 151 on the positive electrode layer side. Similarly, since the negative electrode layer 120 (the negative electrode active material layer 121 and the negative electrode current collector layer 122) is electrically connected to the end-face electrode 152 on the negative electrode layer side, the insulating layer 170 is not disposed between the negative electrode layer 120 and the end-face electrode 152 on the negative electrode layer side.

That is, the solid-state battery of the first embodiment of the present disclosure is a solid-state battery in which the insulating layer 170 is disposed at a minimum. In other words, as shown in FIG. 1D, the insulating layer 170 is not necessarily provided around the solid electrolyte layer 130.

The insulating layer 170 may further contain a filler in addition to the heat-resistant resin. The filler is preferably an insulating filler. The filler is preferably electron insulating, and may have ion conductivity. The filler may have a Young's modulus higher than that of the heat-resistant resin. Such a configuration makes it possible to reduce spreading of the heat-resistant resin in the manufacturing, making integral firing easy. Such a configuration also makes it possible to improve the strength of the insulating layer 170.

The content of the filler is preferably 74 vol % or less in terms of a volume ratio based on the entire insulating layer 170. When the content is more than 74 vol %, the gap between the fillers cannot be filled with the heat-resistant resin, and air bubbles may be mixed.

As an example of the filler, the insulating layer 170 may contain an inorganic material. Examples of the inorganic material include ceramic materials and/or glass materials. The ceramic material is not particularly limited, but examples thereof include at least one selected from the group consisting of aluminum oxide (Al₂O₃), boron nitride (BN), silicon dioxide (SiO₂), silicon nitride (Si₃N₄), zirconium oxide (ZrO₂), aluminum nitride (AlN), silicon carbide (SiC), and barium titanate (BaTiO₃). The glass material is not particularly limited, but examples thereof include at least one selected from the group consisting of silica glass, soda lime glass, potash glass, borate glass, borosilicate glass, barium borosilicate-based glass, zinc borate glass, barium borate glass, borosilicate bismuth salt-based glass, bismuth zinc borate glass, bismuth silicate glass, phosphate glass, aluminophosphate glass, and zinc phosphate glass.

As a modification example of the insulating layer 170 according to an embodiment of the present disclosure, a first insulating layer 171 containing a heat-resistant resin and a second insulating layer 172 containing no heat-resistant resin may be provided as shown in FIG. 1C. The first insulating layer 171 containing a heat-resistant resin may also be disposed between the negative electrode layer 120 and the end-face electrode 151 on the positive electrode layer side and/or between the positive electrode layer 110 and the end-face electrode 152 on the negative electrode layer side. In other words, in a portion around the positive electrode layer 110 and the negative electrode layer 120, the second insulating layer 172 containing no heat-resistant resin may be disposed at a position that does not face the end-face electrode 151 or 152.

In the present disclosure, the number of cracks due to expansion of the battery during charging is relatively large mainly at a position where the end-face electrodes 151 and 152 face the positive electrode layer 110 and the negative electrode layer 120. Therefore, the first insulating layer 171 containing a heat-resistant resin (for example, polyimide resin) has only to be provided at least at the position. In other words, the second insulating layer 172 in another portion around the positive electrode layer 110 and the negative electrode layer 120 may be made of an insulating material (for example, the ceramic material and/or the glass material described above) other than the heat-resistant resin as long as the insulating material has an insulation property. According to the present modification example, the insulating layer containing a heat-resistant resin can be efficiently disposed at a portion where cracks occur due to expansion of the battery during charging.

A protective layer 160 may be formed on the outermost side of the solid-state battery as necessary, and may be provided for electrical, physical, and/or chemical protection. As a material forming the protective layer 160, preferred is a material that is excellent in insulation property, durability and/or moisture resistance, and is environmentally safe. For example, it is preferable to use glass, ceramics, a thermosetting resin and/or a photocurable resin.

The solid-state battery is provided with external terminals that enable connection with the outside. In particular, the end-face electrodes 151 and 152 of the positive and negative electrodes are provided to form a pair on the side faces of the solid-state battery. More specifically, the end-face electrode 151 on the positive electrode layer side, which is connected to the positive electrode layer 110, and the end-face electrode 152 on the negative electrode layer side, which is connected to the negative electrode layer 120, may be provided so as to form a pair. The end-face electrodes 151 and 152 are preferably made of a material having high electron conductivity. Although not particularly limited, the end-face electrodes 151 and 152 may contain at least one selected from the group consisting of silver, gold, platinum, aluminum, copper, tin, and nickel.

The end-face electrodes 151 and 152 may contain a binder and/or a sintering aid. The binder and/or the sintering aid contained in the end-face electrodes 151 and 152 may be selected from, for example, materials similar to the binder and/or the sintering aid that can be contained in the positive electrode active material portion and/or the negative electrode active material portion.

As described above, according to the solid-state battery shown in Embodiment 1 of the present disclosure, the insulating layer 170 contains a heat-resistant resin, and when expansion of the battery occurs during charging, resistance to expansion can be imparted to the insulating layer by the heat-resistant resin. As a result, cracks caused by charging of the battery can be further reduced.

In the present disclosure, as indices for determining cracks due to expansion of the battery during charging, a strain at break ε_{cr} unique to the material is compared with an elastic strain εₑ. When the relationship of strain at break ε_{cr}<elastic strain εₑ is established, it may be determined that cracks occur.

The strain at break ε_{cr0} of the positive electrode layer 110 or the negative electrode layer 120, and the strain at break ε_{cr1} of the insulating layer 170 are values unique to the material. On the other hand, the elastic strain εₑ₀ of the positive electrode layer 110 or the negative electrode layer 120, and the elastic strain εₑ₁ of the insulating layer 170 can be calculated using the following formulas.

$${ε}_{e 0} = - {E}_{1} \times α / ( {E}_{0} + {E}_{1} )$$

$${ε}_{e 1} = {E}_{0} \times α / ( {E}_{0} + {E}_{1} )$$

The Young's modulus of the positive electrode layer 110 or the negative electrode layer 120 is denoted by E₀, the expansion coefficient of the positive electrode layer 110 or the negative electrode layer 120 is denoted by α, and the Young's modulus of the insulating layer 170 is denoted by E₁. In addition, a negative value of the elastic strain εₑ₀ of the positive electrode layer 110 or the negative electrode layer 120 indicates contraction of the positive electrode layer 110 or the negative electrode layer 120, and a positive value of the elastic strain εₑ₁ of the insulating layer 170 indicates expansion of the insulating layer 170.

Further, when both ε_{cr0}>−E₁×α/(E₀+E₁) and ε_{cr1}>E₀×α/(E₀+E₁) are satisfied, it means that cracks due to expansion of the battery during charging are suppressed. Details of the determination indices will be described in Examples. By satisfying the above formulas, it is possible to appropriately reduce cracks due to expansion of the battery during charging.

As a preferred embodiment, the Young's modulus E₁ of the insulating layer 170 may be 0.1 GPa or more and 70 GPa or less. Details of the basis of the numerical range will be described in Examples. By satisfying the requirement of the Young's modulus, it is possible to appropriately reduce cracks due to expansion of the battery during charging.

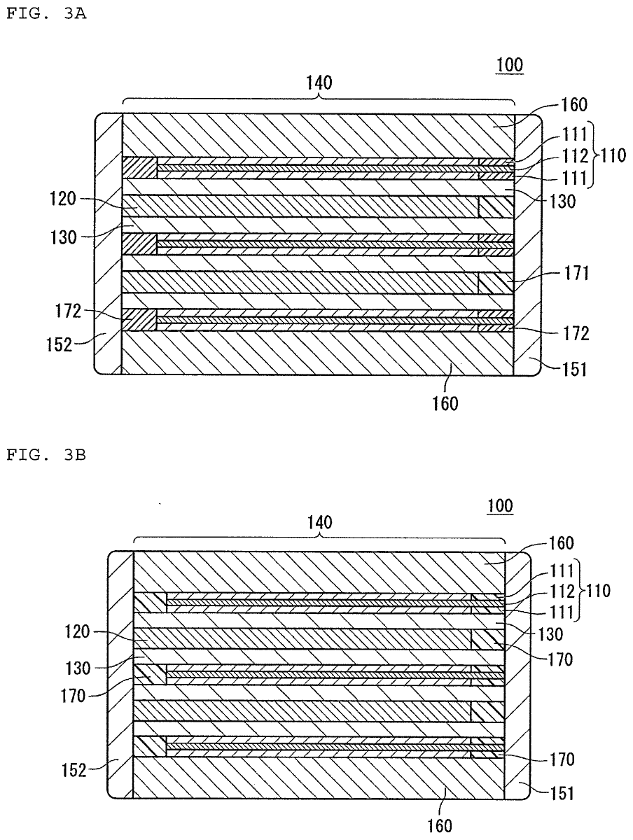

Next, a solid-state battery according to another embodiment of the present disclosure will be described below with reference to FIGS. 2A and 2B. The solid-state battery is different in that aspects of the current collector layers 112 and 122 and the insulating layer 170 are different according to an embodiment. Hereinafter, this different configuration will be described according to an embodiment.

The current collector layers 112 and 122 of the second embodiment may be configured such that a part of these layers is exposed from the active material layers 111 and 121 (see, FIG. 2A). In other words, the lengths of the current collector layers 112 and 122 may be longer than the lengths of the active material layers 111 and 121 in a direction (horizontal direction) in which the end-face electrodes 151 and 152 face each other. More specifically, the current collector layers 112 and 122 may be electrically connected to the end-face electrodes 151 and 152 without electrically connecting the active material layers 111 and 121 to the end-face electrodes 151 and 152. According to such an aspect, the use amount of the active material layers 111 and 121 can be reduced.

In the insulating layer 170 of an embodiment, the insulating layer 170 may be disposed on an outer periphery of the solid electrolyte layer 130 in plan view. According to such an aspect, the insulating layer 170 can act as a protective film for protecting the periphery of the solid electrolyte layer 130.

The current collector layers 112 and 122 are disposed in the insulating layer 170. In other words, the active material layers 111 and 121 are not disposed in the insulating layer 170. According to such an aspect, the current collector layers 112 and 122 and the end-face electrodes 151 and 152 can be appropriately electrically connected.

In other words, when the insulating layer 170 includes the positive electrode current collector layer 112 and negative electrode current collector layer 122, the positive electrode current collector layer 112 and the end-face electrode 151 on the positive electrode layer side may be electrically connected to each other. In this case, the insulating layer 170 may be disposed between the positive electrode active material layer 111 and the end-face electrode 151 on the positive electrode layer side. The negative electrode current collector layer 122 and the end-face electrode 152 on the negative electrode layer side may be electrically connected to each other. In this case, the insulating layer 170 may be disposed between the negative electrode active material layer 121 and the end-face electrode 152 on the negative electrode layer side.

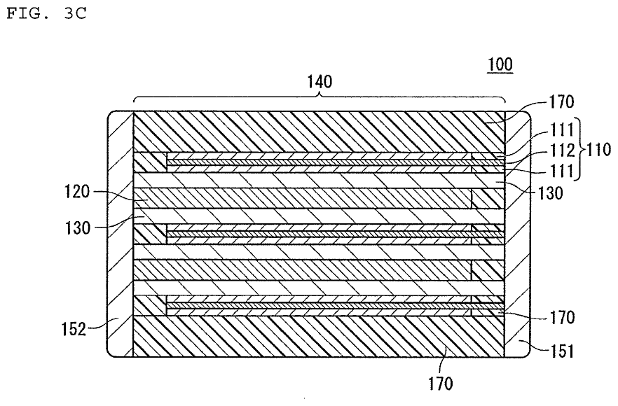

Next, a solid-state battery according to a further embodiment of the present disclosure will be described below with reference to FIGS. 3A to 3C. The solid-state battery is different in that aspects of the positive electrode layer 110, the negative electrode layer 120, the insulating layer 170, and the protective layer 160 are different according to an embodiment. Hereinafter, this different configuration will be described according to an embodiment.

The positive electrode layer 110 according to an embodiment of the present disclosure has a two-layer structure of the positive electrode current collector layer 112 and the positive electrode active material layer 111, while the negative electrode layer 120 may be formed of a single layer. That is, the negative electrode layer 120 is formed of a monolayer (single layer).

In addition, the length of the positive electrode layer 110 and the length of the negative electrode layer 120 may be different in a direction (horizontal direction) in which the end-face electrodes 151 and 152 face each other. In that case, it is preferable to make the positive electrode layer longer than the negative electrode layer.

In the insulating layer according to an embodiment of the present disclosure, the first insulating layer 171 containing a heat-resistant resin may be provided between the negative electrode layer 120 and the end-face electrode 151 on the positive electrode layer side. This is mainly because the insulating layer between the negative electrode layer 120 and the end-face electrode 151 on the positive electrode layer side is easily cracked. An insulating material (for example, the ceramic material and/or the glass material described above) other than the heat-resistant resin may be provided as the second insulating layer 172 between the positive electrode layer 110 and the end-face electrode 152 on the negative electrode layer side, and/or between the positive electrode layer 110 and the end-face electrode 151 on the positive electrode layer side (FIG. 3A). According to such an aspect, it is possible to efficiently dispose the insulating layer containing a heat-resistant resin at a portion where cracks due to expansion of the battery during charging easily occur.

As a modification example of the solid-state battery of the present embodiment, as shown in FIG. 3B, the insulating layer 170 containing a heat-resistant resin may be provided between the negative electrode layer 120 and the end-face electrode 151 on the positive electrode layer side and/or between the positive electrode layer 110 and the end-face electrode 152 on the negative electrode layer side. As described above, by including the heat-resistant resin in the insulating layer 170 located between the positive electrode layer 110 or the negative electrode layer 120 and the end-face electrodes 151 and 152, it is possible to more effectively reduce cracks due to expansion of the battery during charging.

Further, as a modification example of the solid-state battery of the present embodiment, as shown in FIG. 3C, the insulating layer 170 containing a heat-resistant resin may be provided on the outermost side of the solid-state battery. In other words, the insulating layer 170 may be disposed on a part of all of the outermost surfaces of the battery element 140. As described above, by disposing the insulating layer 170, it is possible to more effectively reduce cracks due to expansion of the battery during charging. The outermost layer of the battery element 140 may be a positive electrode layer, a negative electrode layer, a solid electrolyte layer, or a protective layer.

Note that the present disclosure is not limited to the modification example of the solid-state battery shown in FIG. 3C, and the insulating layer 170 may be disposed on at least one outermost surface of the battery element 140. That is, the insulating layer 170 may be disposed on any one of the upper side and the lower side of the battery element 140, and the proportion of the entire insulating layer 170 may be lower than that of the solid-state battery of FIG. 3C according to an embodiment.

Next, a method of manufacturing a solid-state battery will be described according to an embodiment.

The solid-state battery of the present disclosure can be manufactured by a printing method such as a screen printing method or the like, a green sheet method using a green sheet, or a method combining these methods. Hereinafter, a case where the printing method and the green sheet method are adopted for understanding the present disclosure will be described in detail, but the present disclosure is not limited to these methods.

In this step, several types of pastes such as a positive electrode active material portion paste, a negative electrode active material portion paste, a solid electrolyte layer paste, a current collector portion paste, an insulating layer paste, and a protective layer paste are used as ink. That is, a paste having a predetermined structure is formed on a supporting substrate by applying the paste by a printing method.

In the printing, printing layers are sequentially stacked with a predetermined thickness and a predetermined pattern shape, whereby a solid-state battery laminate precursor corresponding to a structure of a predetermined solid-state battery can be formed on the substrate. The type of the pattern forming method is not particularly limited as long as the pattern forming method is a method capable of forming a predetermined pattern, and, for example, any one or two or more of a screen printing method, a gravure printing method, and the like may be used.

The paste can be prepared by wet-mixing a predetermined constituent material of each layer appropriately selected from the group consisting of a positive electrode active material, a negative electrode active material, a conductive material, a solid electrolyte, an insulating material, a binder, and a sintering aid, with an organic vehicle in which an organic material is dissolved in a solvent. The positive electrode active material portion paste can contain, for example, a positive electrode active material, a conductive material, a solid electrolyte, a binder, a sintering aid, an organic material, and a solvent. The negative electrode active material portion paste can contain, for example, a negative electrode active material, a conductive material, a solid electrolyte, a binder, a sintering aid, an organic material, and a solvent. The solid electrolyte layer paste can contain, for example, a solid electrolyte, a binder, a sintering aid, an organic material, and a solvent. The positive electrode current collector portion paste and the negative electrode current collector portion paste can contain a conductive material, an active material, a solid electrolyte, a binder, a sintering aid, an organic material, and a solvent. The insulating layer paste can contain, for example, an insulating material containing a heat-resistant resin (imide-based resin and/or imidazole-based resin), a binder, a sintering aid, an organic material, and a solvent. The protective layer paste can contain, for example, an insulating material, a binder, an organic material, and a solvent.

The organic material contained in the paste is not particularly limited, but at least one polymer material selected from the group consisting of a polyvinyl acetal resin, a cellulose resin, a polyacrylic resin, a polyurethane resin, a polyvinyl acetate resin, a polyvinyl alcohol resin, and the like can be used. The type of the solvent is not particularly limited, and the solvent is, for example, any one or two or more types of organic solvents such as butyl acetate, toluene, terpineol, and N-methyl-pyrrolidone.

In the wet mixing, a medium can be used, and specifically, a ball mill method, a Viscomill method, and the like can be used. In contrast, a wet mixing method without using a medium may be used, and a sand mill method, a high-pressure homogenizer method, a kneader dispersion method, and the like can be used.

The supporting substrate is not particularly limited as long as the supporting substrate is a support capable of supporting each paste layer, and the supporting substrate is, for example, a release film having one surface subjected to a release treatment, or the like. Specifically, a substrate formed of a polymer material such as polyethylene terephthalate can be used. When respective paste layers are subjected to the firing step in a state in which the paste layers are held on the substrate, a substrate that exhibits heat resistance to the firing temperature may be used.

The applied paste is dried on a heated hot plate to form a positive electrode layer green sheet, a negative electrode layer green sheet, a solid electrolyte layer green sheet, an electrode separation green sheet and/or a protective layer green sheet having a predetermined shape and thickness, etc. on the substrate (for example, PET film), respectively.

Next, each green sheet is peeled off from the substrate. After the peeling, the green sheets for the respective constituent elements of one battery constituent unit are sequentially stacked along the stacking direction to form a solid-state battery laminate precursor. After the stacking, the solid electrolyte layer, the electrode separation portion and/or the protective layer may be provided to the side region of the electrode green sheet by screen printing.

In the firing step, the solid-state battery laminate precursor is subjected to firing. Although it is merely an example, firing is performed by heating in a nitrogen gas atmosphere containing oxygen gas, or in an air atmosphere. Firing may be carried out while pressurizing the solid-state battery laminate precursor in the stacking direction (in some cases, stacking direction and direction perpendicular to the stacking direction).

By undergoing such firing, a solid-state battery laminate is formed, so that a desired solid-state battery is finally obtained.

The end-face electrode can be formed by applying a conductive paste to the exposed side face of the positive electrode and the exposed side face of the negative electrode in the battery element. When the end-face electrodes on the positive electrode side and the negative electrode side are provided so as to extend to the lower surface of the battery element, the end-face electrodes can be connected to a mounting land with a small area in surface mounting of the solid-state battery, which is preferable. After the conductive paste is applied, the end-face electrode is fired. Thus, the solid-state battery of the present disclosure can be manufactured.

### EXAMPLES

A demonstration test was conducted on the “solid-state battery” according to the present disclosure. Specifically, solid-state batteries of Comparative Example, and Examples 1 and 2 shown in Table 1 below were manufactured. The structure of FIG. 3C was adopted for the structure of the solid-state battery.

TABLE 1

| | Comparative | | |
|---|---|---|---|
| | Example | Example 1 | Example 2 |
| Negative | Graphite | Graphite | Graphite |
| electrode | Silica glass | Silica glass | Silica glass |
| Insulating layer | Silica glass | Polyimide | Heat-resistant resin |
| between negative | | resin | prepared by mixing |
| electrode and | | | polyimide resin with |
| positive end-face | | | 50% of aluminum oxide |
| electrode | | | powder based on entire |
| | | | insulating layer |
| Positive | LCO | LCO | LCO |
| electrode | Silica glass | Silica glass | Silica glass |
| Insulating layer | Silica glass | Polyimide | Heat-resistant resin |
| between positive | | resin | prepared by mixing |
| electrode and | | | polyimide resin with |
| negative end-face | | | 50% of aluminum oxide |
| electrode | | | powder based on entire |
| | | | insulating layer |

For the solid-state batteries of Comparative Example and Examples, whether or not the insulating layer 170 was cracked was confirmed, and the results shown in the following [Table 2] to [Table 4] were obtained. The presence or absence of cracks was confirmed by performing a simulation (software name: Abaqus) using a finite element method.

As the “expansion coefficient” in the table, characteristic values of the electrode material (positive electrode or negative electrode) due to expansion during charging and discharging were adopted. As the “strain at break (ε_{Cr})”, the physical property value of the material used was adopted. The “elastic strain (εₑ)” was calculated using the formulas for calculating the elastic strain εₑ₀ of the positive electrode layer 110 or the negative electrode layer 120 and the elastic strain εₑ₁ of the insulating layer 170, and using the formula of εₑ₀=−E₁×α/(E₀+E₁) or εₑ₁=E₀×α/(E₀+E₁) as described above.

Results regarding solid-state battery of Comparative Example

TABLE 2

| | | Insulating layer | | Insulating layer |
|---|---|---|---|---|
| | | between negative | | between positive |
| | | electrode and | | electrode and |
| | Negative | positive end-face | Positive | negative end-face |
| | electrode | electrode | electrode | electrode |
| Material | Graphite | Silica glass | LCO | Silica glass |
| | Silica glass | | Silica glass | |
| Young's modulus | 34 | 73 | 110 | 73 |
| (GPa) | | | | |
| Expansion | 0.025 | — | 0.006 | — |
| coefficient | | | | |
| Strain at break | >0 | 0.0027 | >0 | 0.0027 |
| (ε_{cr}) | | | | |
| Elastic strain | −0.017 | 0.0079 | −0.0024 | 0.0036 |
| (εₑ) | | | | |
| Presence or | Absent | Present | Absent | Present |
| absence of crack | | | | |

Results regarding solid-state battery of Example 1

TABLE 3

| | | Insulating layer | | Insulating layer |
|---|---|---|---|---|
| | | between negative | | between positive |
| | | electrode and | | electrode and |
| | Negative | positive end-face | Positive | negative end-face |
| | electrode | electrode | electrode | electrode |
| Material | Graphite | Polyimide | LCO | Polyimide |
| | Silica glass | resin | Silica glass | resin |
| Young's modulus | 34 | 4.2 | 110 | 4.2 |
| (GPa) | | | | |
| Expansion | 0.025 | — | 0.006 | — |
| coefficient | | | | |
| Strain at break | >0 | 0.05 | >0 | 0.05 |
| (ε_{cr}) | | | | |
| Elastic strain | −0.0027 | 0.022 | −0.0002 | 0.0058 |
| (εₑ) | | | | |
| Presence or | Absent | Absent | Absent | Absent |
| absence of crack | | | | |

Results regarding solid-state battery of Example 2

TABLE 4

| | | Insulating layer | | Insulating layer |
|---|---|---|---|---|
| | | between negative | | between positive |
| | | electrode and | | electrode and |
| | Negative | positive end-face | Positive | negative end-face |
| | electrode | electrode | electrode | electrode |
| Material | Graphite | Heat-resistant | LCO | Heat-resistant |
| | Silica glass | resin prepared by | Silica glass | resin prepared by |
| | | mixing polyimide | | mixing polyimide |
| | | resin with 50% of | | resin with 50% of |
| | | aluminum oxide | | aluminum oxide |
| | | powder based on | | powder based on |
| | | entire insulating | | entire insulating |
| | | layer | | layer |
| Young's modulus | 34 | 8.3 | 110 | 8.3 |
| (GPa) | | | | |
| Expansion | 0.025 | — | 0.006 | — |
| coefficient | | | | |
| Strain at break | >0 | 0.026 | >0 | 0.026 |
| (ε_{cr}) | | | | |
| Elastic strain | −0.0049 | 0.020 | −0.0004 | 0.0056 |
| (εₑ) | | | | |
| Presence or | Absent | Absent | Absent | Absent |
| absence of crack | | | | |

According to the above results, in Examples 1 and 2 in which the insulating layer 170 contained a heat-resistant resin (polyimide resin), cracks of the insulating layer 170 during charging and discharging were reduced. On the other hand, in Comparative Example in which the insulating layer 170 did not contain a heat-resistant resin, some cracks of the insulating layer 170 were observed during charging and discharging.

Further, in Examples 1 and 2 in which the Young's modulus of the insulating layer 170 was in the range of 0.1 GPa or more and 70 GPa or less, cracks of the insulating layer 170 during charging and discharging were reduced. On the other hand, in Comparative Example in which the Young's modulus of the insulating layer 170 was 70 GPa or more, some cracks of the insulating layer 170 were observed during charging and discharging.

Further, in Examples 1 and 2, the negative electrode, the positive electrode, and the insulating layer satisfied the relationship of strain at break (ε_{Cr})>elastic strain (εₑ). That is, ε_{cr0}>−E₁×α/(E₀+E₁) and ε_{cr1}>E₀×α/(E₀+E₁) were satisfied, and cracks of the insulating layer 170 during charging and discharging were reduced. On the other hand, in Comparative Example, the negative electrode and the positive electrode satisfied the relationship of strain at break (ε_{Cr})>elastic strain (εₑ), but the insulating layer did not satisfy the relationship of strain at break (ε_{Cr})>elastic strain (εₑ). That is, since ε_{cr0}>−E₁×α/(E₀+E₁) and ε_{cr1}>E₀×α/(E₀+E₁) were not satisfied, some cracks of the insulating layer 170 were observed during charging and discharging.

Further, when the content of the filler (aluminum oxide powder) was 74% or less based on the entire insulating layer as in the solid-state battery of Example 2, cracks of the insulating layer 170 during charging and discharging were reduced.

It is to be noted that embodiments disclosed herein are considered by way of illustration in all respects, and not considered as a basis for restrictive interpretations. Accordingly, the technical scope of the present disclosure is not to be construed only by the embodiments mentioned above. In addition, the technical scope of the present disclosure encompasses equivalent meanings and all suitable modifications. For example, the solid-state battery is not limited to a substantially hexahedral shape, and may have a polyhedral shape, a cylindrical shape, or a spherical shape.

### INDUSTRIAL APPLICABILITY

The packaged solid-state battery of the present disclosure can be used in various fields in which battery use or electricity storage is assumed. Although it is merely an example, the packaged solid-state battery of the present disclosure can be used in the electronics packaging field. The present disclosure can be used in electricity, information and communication fields where mobile equipment and the like are used (e.g., electrical/electronic equipment fields or mobile device fields including mobile phones, smart phones, laptop computers, digital cameras, activity meters, arm computers, electronic papers, and small electronic devices such as RFID tags, card type electronic money, and smartwatches), domestic and small industrial applications (e.g., the fields such as electric tools, golf carts, domestic robots, caregiving robots, and industrial robots), large industrial applications (e.g., the fields such as forklifts, elevators, and harbor cranes), transportation system fields (e.g., the fields such as hybrid vehicles, electric vehicles, buses, trains, electric assisted bicycles, and two-wheeled electric vehicles), electric power system applications (e.g., the fields such as various power generation systems, load conditioners, smart grids, and home-installation type power storage systems), medical applications (medical equipment fields such as earphone hearing aids), pharmaceutical applications (the fields such as dose management systems), IoT fields, and space and deep sea applications (e.g., the fields such as spacecraft and research submarines) .

### DESCRIPTION OF REFERENCE SYMBOLS

100: Solid-state battery
110: Positive electrode layer
111: Positive electrode active material layer
112: Positive electrode current collector layer
120: Negative electrode layer
121: Negative electrode active material layer
122: Negative electrode current collector layer
130: Solid electrolyte layer
140: Battery element
151: End-face electrode on positive electrode layer side
152: End-face electrode on negative electrode layer side
160: Protective layer
170: Insulating layer
171: First insulating layer
172: Second insulating layer

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A solid-state battery comprising:
a battery element in which a positive electrode layer, a negative electrode layer, and a solid electrolyte layer interposed between the positive electrode layer and the negative electrode layer are stacked;
an end-face electrode provided on an end face of the battery element; and
an insulating layer provided between the positive electrode layer or the negative electrode layer and the end-face electrode, wherein the insulating layer contains a heat-resistant resin.

2. The solid-state battery according to claim 1, wherein the insulating layer is disposed between the positive electrode layer and the end-face electrode, and between the negative electrode layer and the end-face electrode.

3. The solid-state battery according to claim 1, wherein
the end-face electrode includes:
a positive end-face electrode electrically connected to the positive electrode layer; and
a negative end-face electrode electrically connected to the negative electrode layer, and
the insulating layer is disposed between the positive end-face electrode and the negative electrode layer.

4. The solid-state battery according to claim 3, wherein the insulating layer is disposed between the negative end-face electrode and the positive electrode layer.

5. The solid-state battery according to claim 1, wherein
the positive electrode layer or the negative electrode layer includes: an active material layer containing an electrode active material; and a current collector layer, and
the insulating layer is disposed between the active material layer and the end-face electrode.

6. The solid-state battery according to claim 1, wherein the insulating layer is disposed between the solid electrolyte layer and the end-face electrode.

7. The solid-state battery according to claim 1, wherein the positive electrode layer includes a positive electrode current collector layer and a positive electrode active material layer, and
the negative electrode layer is formed of a single layer.

8. The solid-state battery according to claim 1, wherein the insulating layer is disposed on at least one of outermost surfaces of the battery element.

9. The solid-state battery according to claim 1, wherein the insulating layer is disposed on a part of all of the outermost surfaces of the battery element.

10. The solid-state battery according to claim 1, wherein
ε_{cr0}>−E₁×α/(E₀+E₁) and ε_{cr1}>E₀×α/(E₀+E₁) are satisfied
when a Young's modulus of the positive electrode layer or the negative electrode layer is denoted by E₀, an expansion coefficient of the positive electrode layer or the negative electrode layer is denoted by α, a strain at break of the positive electrode layer or the negative electrode layer is denoted by ε_{cr0}, a Young's modulus of the insulating layer is denoted by E₁, and a strain at break of the insulating layer is denoted by ε_{cr1}.

11. The solid-state battery according to claim 1, wherein a Young's modulus of the insulating layer is 0.1 GPa or more and 70 GPa or less.

12. The solid-state battery according to claim 1, wherein the insulating layer further contains a filler.

13. The solid-state battery according to claim 12, wherein the filler contains an inorganic material.

14. The solid-state battery according to claim 13, wherein the inorganic material contains aluminum oxide.

15. The solid-state battery according to claim 1, wherein a content of the filler contained in the insulating layer is 74 vol % or less.

16. The solid-state battery according to claim 1, wherein the positive electrode layer, the negative electrode layer, the solid electrolyte layer, and the insulating layer contain an integrally fired body.

17. A solid-state battery comprising:
a battery element in which a positive electrode layer, a negative electrode layer, and a solid electrolyte layer interposed between the positive electrode layer and the negative electrode layer are stacked; and
an end-face electrode provided on an end face of the battery element, wherein
the positive electrode layer and/or the negative electrode layer includes an electrode active material layer and a current collector layer, and
the current collector layer contains a conductive material and a heat-resistant resin.

18. The solid-state battery according to claim 17, further comprising an insulating layer provided between the positive electrode layer or the negative electrode layer, and the end-face electrode, wherein
the insulating layer contains a heat-resistant resin.

19. The solid-state battery according to claim 17, wherein the conductive material is a carbon material and/or a metal material.

20. The solid-state battery according to claim 1, wherein the heat-resistant resin contains an imide-based resin and/or an imidazole-based resin.

21. The solid-state battery according to claim 1, wherein the positive electrode layer and the negative electrode layer are layers capable of storing and releasing lithium ions.
